(19) United States
(12) Patent Application Publication
(10) Pub. No.: US 2019/0253332 A1
(43) Pub. Date: Aug. 15, 2019

(54) CORRELATED PAGE RESOURCES FOR SINGLE PAGE APPLICATIONS

(71) Applicant: CA, Inc., New York, NY (US)

(72) Inventors: Douglas Briere, Cupertino, CA (US); Ramesh Mani, Fremont, CA (US); Nikhil Kasthurirangan, Santa Clara, CA (US); Yash Sangani, San Jose, CA (US)

(21) Appl. No.: 15/894,202

(22) Filed: Feb. 12, 2018

(51) Int. Cl. H04L 12/26; G06F 17/30; G06F 3/0483; H04L 29/08

(52) U.S. Cl. CPC H04L 43/0817; G06F 17/3089; H04L 67/02; G06F 17/30864; G06F 3/0483; G06F 17/30902

(57) ABSTRACT

A method includes performing, by a processor, receiving a user selection of a content item on a web page in a web browser executing on a device, determining a selection time associated with the user selection of the content item, identifying, based on the selection time, a page bucket for a web resource associated with the content item that was selected, associating the web resource with the page bucket that was identified, and communicating, to a network operator, performance information associated with the web page based on the page bucket.

### BACKGROUND

Worldwide access to the World Wide Web has led to organizations and businesses using web sites as a means to provide information to customers. With faster network speeds to access web sites and increased content on the Web, the performance and speed of operation and navigation of web sites may be important to web site owners. Network providers wish to quantify the performance of web sites and improve the operation and trouble shooting of web sites. While performance management software may be used to collect diagnostic data on web site performance, an administrator or other engineering staff may lack tools for analyzing the diagnostic information and identifying the source of performance problems or mitigate the effects of performance problems.

### SUMMARY

Various embodiments of the present invention are directed to a method including performing operations follows on a processor. The operations include receiving a user selection of a content item on a web page in a web browser executing on a device, determining a selection time associated with the user selection of the content item, identifying, based on the selection time, a page bucket for a web resource associated with the content item that was selected, associating the web resource with the page bucket that was identified, and communicating, to a network operator, performance information associated with the web page based on the page bucket.

In some embodiments, the method may include determining an occurrence of a route change based on whether a second web address associated with the user selection of the content item is different from a first web address that was used before the user selection of the content item. The identifying the page bucket may further include identifying the page bucket based on a route time associated with the route change. Responsive to a lack of the occurrence of the route change, the processor may perform operations including inspecting an element associated with the content item, determining the selection time based on the element associated with content item, and creating the page bucket for the web resource.

In some embodiments, inspecting the element may include responsive to the receiving the user selection, walking a hierarchy associated with the content item, identifying a single page application (SPA) tag in the hierarchy, and creating the page bucket for the web resource, responsive to the identifying the SPA tag. Identifying the page bucket may include identifying the page bucket associated with the selection time, responsive to a determination that the page bucket associated with the selection time exists, creating a new page bucket, responsive to a determination that page bucket associated with the selection time does not exist, and identifying the new page bucket as the page bucket for the web resource associated with the content item that was selected.

In some embodiments, method may include recording the selection time associated with the user selection, determining that a new page bucket is needed, responsive to the selection time associated with the content item, determining a current time, that is later than the selection time, for creating the new page bucket, creating the new page bucket at the current time, responsive to the determining that the new page bucket is needed, and associating the new page bucket with the selection time that was recorded. Associating the new page bucket with the selection time may include associating the new page bucket with the selection time that was recorded, responsive to a difference in the current time and the selection time being less than a threshold time. Determining that the new page bucket is needed may occur responsive to identification of a single page application (SPA) tag in a hierarchy associated with the content item.

In some embodiments, web resource information associated with the web resource may be in a resource table. The method may include assigning the web resource information that is in a resource table to the page bucket, based on a timestamp associated with the web resource information that is in the resource table. Assigning the web resource information may occur at a harvest time that is after the current time. Assigning the web resource may be based on a periodic polling time interval. The performance information associated with the web page may include performance information associated with the web resource information that was assigned to the page bucket.

In some embodiments, performance information associated with the web page may be organized in a hierarchical structure before being communicated to the network operator. The page bucket may be one of a plurality of page buckets. Identifying the page bucket may include performing a binary search on respective ones of selection times associated with the plurality of page buckets to determine the page bucket for the web resource.

Various embodiments described herein can provide an electronic device including a processor and a memory coupled to the processor and comprising computer readable program code embodied in the memory that when executed by the processor causes the processor to perform operations including receiving a user selection of a content item on a web page in a web browser executing on a device, determining a selection time associated with the user selection of the content item, identifying, based on the selection time, a page bucket for a web resource associated with the content item that was selected, associating the web resource with the page bucket that was identified, and communicating, to a network operator, performance information associated with the web page based on the page bucket.

Various embodiments described herein can provide a computer program product, including a non-transitory computer readable storage medium storing computer readable program code which when executed by a processor of an electronic device causes the processor to perform operations including receiving a user selection of a content item on a web page in a web browser executing on a device, determining a selection time associated with the user selection of the content item, identifying, based on the selection time, a page bucket for a web resource associated with the content item that was selected, associating the web resource with the page bucket that was identified, and communicating, to a network operator, performance information associated with the web page based on the page bucket.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a user device for which performance information may be provided to a network operator, according to some embodiments of the present inventive concept.

FIGS. 2 and 7 are flowcharts of operations for time-based selection of page buckets for performance information, according to some embodiments of the present inventive concept.

FIGS. 3,4, and 6 are timing diagrams of page buckets associated with web page navigation, according to some embodiments of the present inventive concept.

FIG. 5 is resource table of pages and the associated resources, according to some embodiments of the present inventive concept.

FIG. 8 is an example of performance information related to content items in a web page, according to some embodiments of the present inventive concept.

FIGS. 9 to 17 are flowcharts that illustrate operations for correlated page resources for single page applications, according to some embodiments of the present inventive concept.

FIG. 18 is a block diagram that illustrates a software/hardware architecture for use in the electronic device of FIG. 1, according to some embodiments of the present inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Businesses, applications, organizations, and/or groups use web pages as an interface to users. Ubiquitous availability of computers and/or mobile devices provide access to most persons worldwide to a web browser capable of connecting to the internet and accessing websites associated with businesses, applications, organizations, and/or groups. Websites may include numerous web pages that each provides different information to users. Some websites may have a separate web page for each use case, such as a home page (home.html), products page (products.html), about page (about.html), etc. These separate pages may be referred to as hard pages. Some websites do not navigate from web page to web page. These websites may have a single hard page such as, for example, index.html, and dynamically changing content within that page. This dynamic content may be used to update the information on the screen, but it may also be used to change the view of the page entirely. For example, when a user navigates from the home page to the products page the page content changes, but the Uniform Resource Locator (URL) may remain at index.html. This type of web page is often referred to as a single page application (SPA) and navigation to different “pages” (such as home or products) would still occur on the URL index.html. These pages within a single page application may be referred to as soft pages. Additionally, in some embodiments, a hard page may occur, on navigation to a different page may not occur. As a non-limiting example, navigation may proceed to a hard page such as index.html. The web server may choose to respond with specific content when the domain is accessed, but not necessarily with a specific file. As a non-limiting example, the domain www.<domain>.com may include soft page references to the domain page. Soft pages such as www.<domain>.com/softpage1 or www.<domain>.com/softpage2 may be referenced to the www.<domain>.com main page.

Soft pages may present challenges for network operators with respect to performance measurements and identification of poorly performing sections of the website. Various embodiments described herein may arise from a recognition that web page resources associated with web pages may be correlated to user selections, such as clicks on a web page. Specifically, the web page resources may be correlated with time intervals associated with user selections. Therefore, these soft pages may be sorted into logical pages or grouping buckets (i.e. page buckets) to accumulate performance measurements. Additionally, supporting web resources for the soft pages, such as scripts, CSS, images, etc, will then be associated/correlated to the logical page/soft page.

A single page application may include hundreds or even thousands of supporting resources likes scripts, images, CSS files, etc. Various embodiments described herein identify the logical soft pages and correlate resources for each soft page. These techniques may provide a superior organization structure for performance information, which may be beneficial when providing the performance information within a visualization interface to a network operator. Ultimately, increased organization of the performance data may enable a network operator to efficiently perform root cause analysis of poor web page performance.

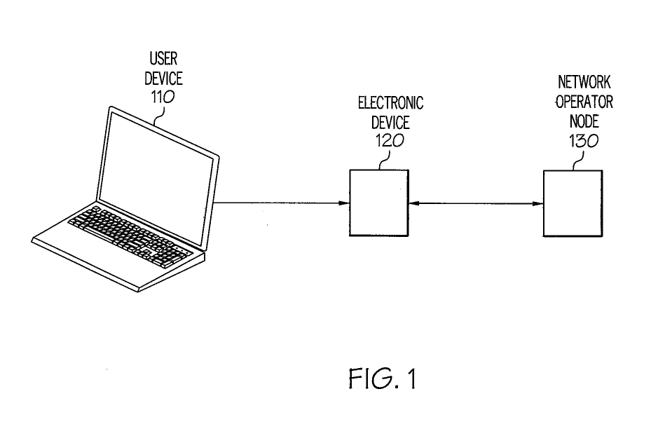

FIG. 1 is a block diagram that illustrates a communication network including a user device for which performance information may be provided to a network operator. As used herein, the term “user device” may include a personal computer, a satellite or cellular radiotelephone with or without a multi-line display, a Personal Communications System (PCS) terminal that may combine a cellular radiotelephone with data processing, facsimile and data communications capabilities, a Personal Digital Assistant(PDA) or smart phone that can include a radiotelephone, pager, Internet/intranet access, Web browser, organizer, calendar and/or a Global Positioning System (GPS) receiver, a conventional laptop and/or palmtop receiver, and/or other appliance that includes a communication transceiver. As used herein, an “electronic device” may include any of the types of devices that perform as a user device. An “electronic device” may include servers, data center equipment, or other devices that include a communication transceiver and/or a processor. As used herein, a “network operator” may include a service provider, web hosting service, Internet/Intranet administrator nodes, and/or other nodes in a communications network. As used herein, a “selection” may be user selection in a web browser by specifying a URL, a mouse click, touch screen selection and/or other indication from a user to navigate within a web browser.

Referring now to FIG. 1, a user device 110 may be used to execute a web browser. A user may use an interface, such as a mouse and/or keyboard, to provide a user selection to navigate to a web page in the web browser. An electronic device 120 may perform operations to identify web resources associated with the user selection. In some embodiments, the user device 110 and the electronic device 120 may be co-located and/or integrated into a single housing. The electronic device 120 may communicate performance information related to the web page accessed by the user to a network operator node 130. In some embodiments, the electronic device 120 and/or a network operator node 130 may be co-located and/or integrated into a single housing. In some embodiments, the user device 110, the electronic device 120, and/or the network operator node 130 may be physically separated from one another communicate with one another using transceivers in the various devices across one or more networks.

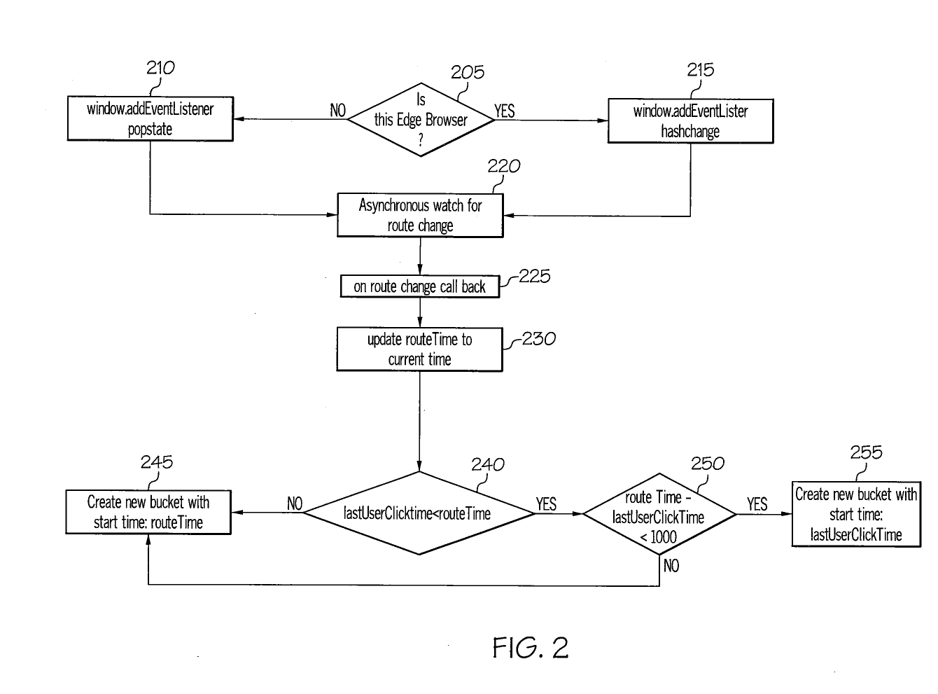

User selections, such as user mouse click events, may be watched on some or all web page components in order to keep track of the last user selection time/click time. The mouse click by itself may not be sufficient to determine a route change pertaining to a change in the URL. Therefore, a route change may be also monitored since some single page applications trigger on route change events. In some cases, browsers may start downloading resources before a route change is triggered by an event such as a JavaScript event listener call back. A potential problem may occur in these cases since the JavaScript performance resources table may have start time entries prior to a new soft page being loaded. Therefore, when creating a page bucket for the logical soft page, there may be a bias to use the user's selection/click time, which likely was initiated by the route change. Using the user's selection time may be more accurate as long as the click happens sometime earlier in time than the route change time and within some tolerable threshold such as, for example, a threshold time no greater than 1000 msec. By enforcing the threshold time, a stale client click time will not be used, which may occur in cases, such as if the mouse click call back could not be registered on some or all web page components. FIG. 2 is a flow chart of operations related to the case of a route change.

Referring now to FIG. 2, example embodiments relate to implementation of a case where the URL changes based upon a user selection will be discussed. Several browsers support a popstate event handler that triggers when a user makes a selection on a web page. However, the Microsoft Edge browser, which is included with Windows 10, does not implement the popsate callback in its specification thus must be handled differently. A check is performed if the browser is an Edge browser, at block 205. If the browser is an Edge browser, window.addEventListen hashchange is called, at block 215. If the browser is not an Edge browser, window.addEventListen popostate is called, at block 210. An asynchronous watch for a route change is performed, at block 220. When the route change callback occurs, at block 225, the route time is updated to the current time, at block 230. A check is performed to make sure that the route change time occurred after the selection/click by determining if the last user selection/click time is less than the route time, at block 240. If this is the case, then a check is performed to determine if a difference between the route change and the last user selection/click time is less than a threshold time, such as 1000 msec, at block 250. If the time difference is less than below the threshold time, then a new page bucket is created and associated with the last user selection/click time, at block 255. At block 240, if the route time was less than the last user selection/click time of if the threshold check failed, a new page bucket is creating and associated with the route time, at block 245. The route time may be less than the last user selection/click time in cases where the user is providing multiple clicks with a very short time period between clicks.

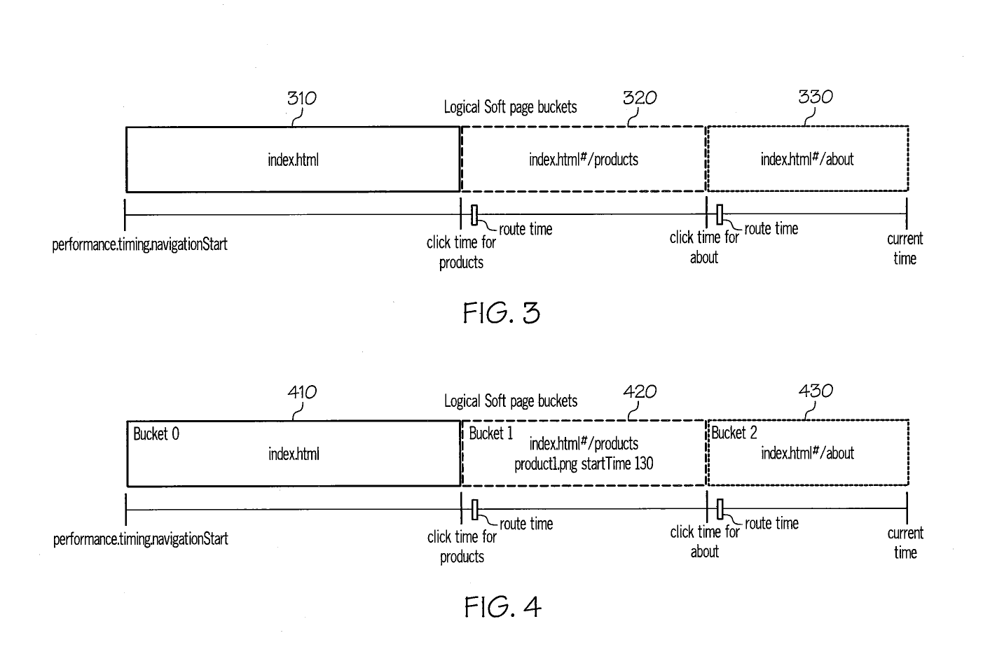

FIG. 3 is a timing diagram of page bucket creation associated with web page navigation. A single page application may be available at the URL index.html. A user may navigate to a “products” page, and then navigate to an “about” page. These actions by the user may trigger operations in the flow chart of FIG. 2, resulting in the timeline of FIG. 3, according to some embodiments. Referring now to FIG. 3, a user may navigate to the web page index.html 310 at a time of performance.timing.navigationStart. The user may select/click on the products page, index.html#/products 320 at the click time for products. The route may change at a time later than the click time for products, in the time window illustrated as route time. The user may select/click on the about page, index.html#/about 330 at the click time for about. The route time associated with the “products” page may change after the user has already clicked on the “about” page. This information may not be available to the processing device until the current time. For the “products” page, the click time associated with the “products” page may be used in conjunction with the route time associated with the “products” page to determine a page bucket for web resources associated with the “products” page.

If a page bucket has not been previously created for a particular web page a new page bucket may be created. The page bucket is used to associate web resources associated with a particular web page that was accessed based on a user selection. Web resources may include any resources that support the web page such as files, images, scripts, or calls to data via asynchronous web applications such as Asynchronous JavaScript and XML (AJAX). These web resources may be entered into a resource table when they are downloaded, executed, and/or called. The resource table may be harvested at different points in time after creation of the page bucket in order to associate resource table entries such as the web resources with the page bucket.

Implementation of the concepts described herein may include a Document Object Model (DOM), which is a cross-platform and language-independent application programming interface that treats a HTML, XHTML, or XML document as a tree structure wherein each node is an object representing a part of the document. Asynchronous web applications such as Asynchronous Javascript and XML (AJAX) may be used on the web page. Asynchronous Javascript and XML (AJAX) is a set of web development techniques using many web technologies on the client side to create asynchronous web applications. With AJAX, web applications may send and/or retrieve data from a server asynchronously in the background without interfering with the display and behavior of the existing web page. By decoupling the data interchange layer from the presentation layer, AJAX allows for web pages, and by extension web applications, to change content dynamically without the need to reload the entire page. In practice, modern implementations commonly substitute JavaScript Object Notation (JSON) for XML due to the advantages of JSON being native to JavaScript.

The resource table, which may include web resources used by AJAX calls, may be harvested by periodic polling. In a non-limiting example, JavaScript resources (performance.getEntriesByType(“resource”)) may be polled on a regular interval. The entries in the resource table include a start time of when the web resource started to be downloaded after the user clicked on the web page. The start times may be based on the JavaScript object DOMHighResTimeStamp, which may be an offset from the navigation start time of the page that is obtained via performance.timing.navigationStart. The navigation start time of the page may be when the page was opened by the user. Summing the two aforementioned time values may provide a result that can be used to determine which page bucket the web resource should be associated to.

Web table harvesting, according to various embodiments described herein, may be used to provide information related to web page navigation to a network operator and/or data center operator. Information regarding the performance of various web pages and/or web resources may be provided to a client in batches at suitable time intervals. For example, the performance information may be in a Javascript Object Notation (JSON) format and periodically sent to the network operator.

In some embodiments, since there could be hundreds or thousands of web resources in the resource table, efficiently accomplishing harvesting of the resource table may include performing a binary search of the page bucket start times to find an appropriate page bucket for a given web resource. If an index into the binary search of the web sources results in nothing being found, a negative number may be returned by the search. If a positive number is returned from the search, adding 1 and dropping the sign may result in an appropriate location where the item should be inserted.

FIG. 4 illustrates the timing of a non-limiting example of the use of logical soft page buckets for web page navigation performance. Referring now to FIG. 4, the main web page, index.html 410 may be entered at the performance.timing.navigationStart=30 msec. Page bucket 0 may be created for web page index.html 410. The user may select the “products” web page, index.html#/products 420 at click time=101 msec. The user may then select the “about” web page, index.html#/about 430, which is associated with page bucket 2. The processing of this user's navigation may occur at some time after the click to the “about” web page, labeled as the current time.

Still referring to FIG. 4, in response to the user's selection of the “products” page, an image product1.png may be downloaded to the user's web browser at startTime=130 msec, such that the route time starts at startTime=130 msec. The actual start time of product1.png is 30 msec (navigation start)+130 msec (offset) for total of 160 msec. The time value of 160 msec will be searched against web bucket start times of [30 msec, 101 msec, 310 msec]. In some example implementations, the binary search may return −3. Using an example processing technique, adding 1 and dropping the sign results in 2, which indicates that time value associated with product1png is inserted at an index of 2 of the array, resulting in a time array of [30, 101, 160, 310]. In this case, a new page bucket will not be created, since this web resource is associated with an existing page bucket. In actuality, page bucket 1 is used since the index will be directed to the bucket start time associated with the user click, i.e. 101 msec in this case. In some example embodiments, it is possible that that binary search returns a positive number, such as 1, in which case a web resource was accessed at the exact start time of the bucket.

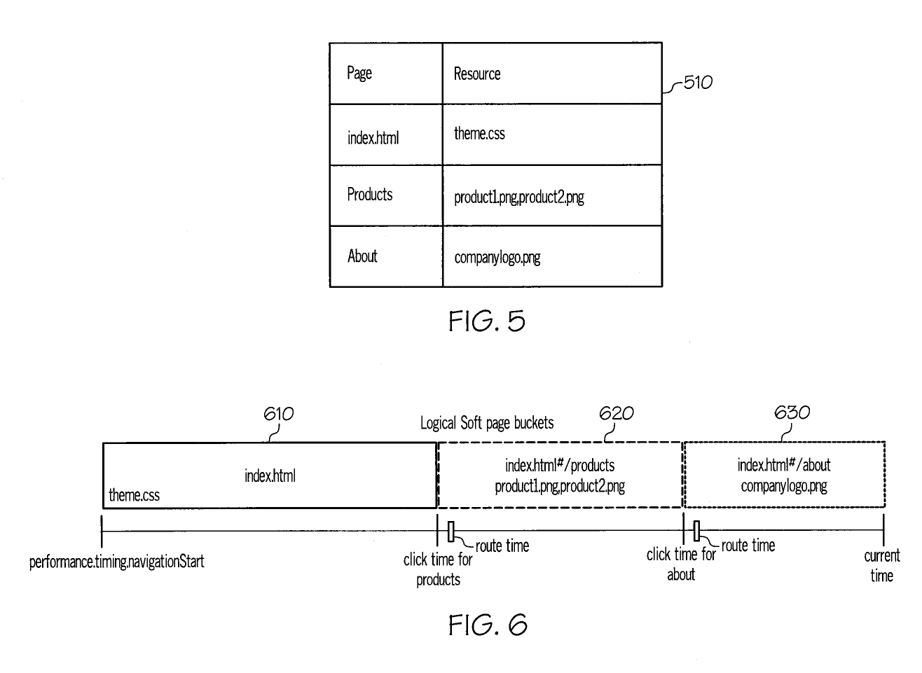

FIG. 5 illustrates an example resource table, which may be associated with the navigation of FIG. 4. Referring now to FIG. 5, the resource table 510 may include web pages such as index.html that uses web resource theme.css, products that use image web resources product1.png and product2.png, and the web page about that uses the image web resource companylogo.png.

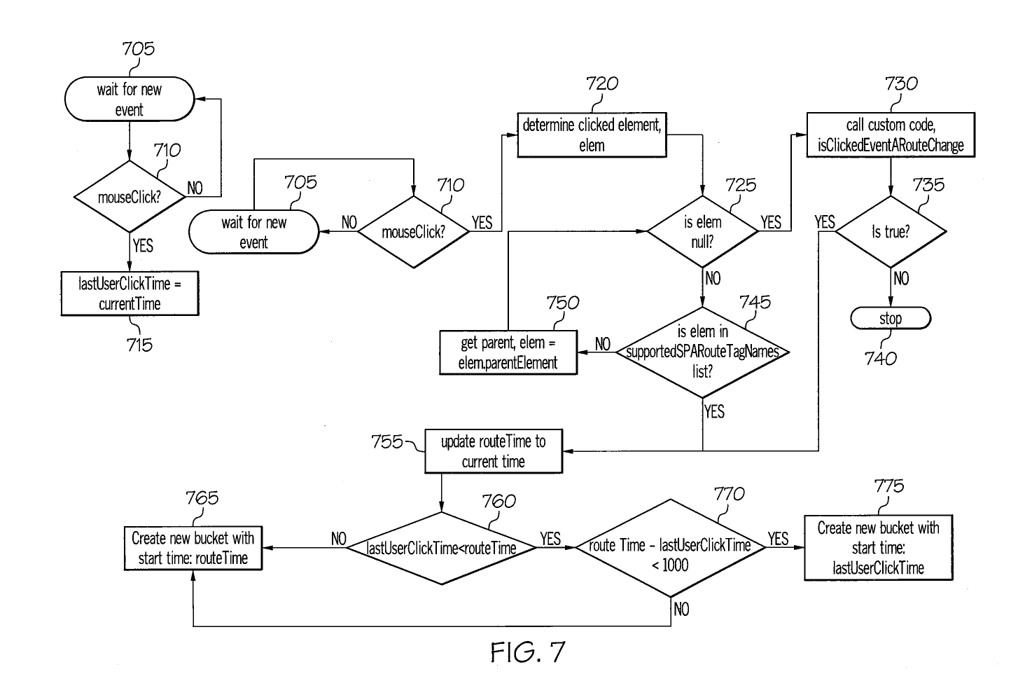

The web resources of the resource table 510 of FIG. 5 may be allocated to logical soft page buckets as illustrated in FIG. 6. Referring now to FIG. 6, a user may navigate to the web page index.html 610 at a time of performance.timing.navigationStart. The web resource theme.css may be invoked responsive to user navigation to the web page index.html 610. The user may select/click on the products page, index.html#/products 620 at the click time for products. The route may change at a time later than the click time for products, in the time window illustrated as route time. The user may select/click on the about page, index.html#/about 630 at the click time for “about”, invoking the web resource companylogo.png. The route time associated with the “products” page may change after the user has already clicked on the “about” page. In this case, it may be difficult to determine if the route change was due to the click on the “products” web page or on the “about” web page. As a result, in some embodiments, it may be advantageous to use the user selection time but not the route time to determine the page bucket for associating web resources, as will now be discussed with respect to FIG. 7.

FIG. 7 illustrates a flowchart of operations for time-based selection of page buckets for performance information, according to some embodiments. Referring now to FIG. 7, the event handler waits for notification of a new event, at block 705. Upon notification of an event, a check is performed to determine if a user selection such as a mouse click has occurred, at block 710. If a mouse click has occurred, then the lastUserClickTime associated with the mouse click is set to the current time, at block 715. Additionally, upon the occurrence of the mouse click of block 710, the element that was selected/clicked may be determined, at block 720. A check is performed to determine if the selected element is null, at block 725. If the selected element is null, then network operator and/or user configured customized code may be executed to determine if the clicked event has caused a route change of the URL, at block 730. The customized code may include a single page application (SPA) tag that is customer and/or network operation specific. A check is performed to determine if a route change has occurred, at block 735. If no route change has occurred, no action is taken, at block 740.

Still referring to FIG. 7, if the selected element is not null at block 725, then a check is performed to determine if the selected element includes a supported tag name such as, for example, a tag name in supportedSPARouteTagNames list, at block 745. If it is not a supported tag, the parent element may be checked using, for example, get.parent.elem=elem.parentElement, at block 750. Flow then returns to block 725. At block 745, if the selected element includes a supported tag name, the route time is updated to the current time, at block 755. A check is performed to determine if the last user click time is less than the route time to determine if there were multiple clicks in the intervening time period, at block 760. If the last user click time is less than the route time, then a check is performed to determine if a difference between the route time and the last user click time is less than a threshold value such as, for example, 1000 msec, at block 770. If the difference between the route time and the last user click time is less than a threshold value, a new page bucket may be created with an associated start time that is the last user click time, at block 775. If the difference between the route time and the last user click time is not less than a threshold value, a new page bucket may be created with an associated start time that is the route time, at block 765.

FIG. 8 is an example of performance information related to content items in a web page, according to some embodiments described herein. Referring now to FIG. 8, the performance information 810 may include memory sizes used, page timing that is associated with navigation timing, and/or performance time associated with resource performance timing. The resources may be categorized based on various timing or other parameters to highlight the user's perception of why certain web pages and/or content items are slow to load.

A working example will now be discussed in detail to aid in understanding the operations discussed with respect to FIGS. 2 to 7. Although the working example is described in the context of Google urls, these examples are intended as non-limited working examples, any urls may be used with respect to the concepts described herein. The following example HTML code is considered when the web address is entered in the web browser. <script type=“text/javascript” src=“https://ajax.googleapis.com/ajax/libs/angularjs/1.5.8/angular.min.js”></script>. In this above code segment, the delineators <script></script> may be referred to as the DOM/HTML Element. As discussed earlier, a web resource is any data that supports the page such as files, images, scripts or calls to obtain information via AJAX. In this working example, https://ajax.googleapis.com/ajax/libs/angularjs/1.5.8/angular.min.js would be considered the web resource. Another example may include static resources that are hardcoded on the HTML page, such as <link rel=“stylesheet” type=“text/css” href=“https://ajax.googleapis.com/ajax/libs/angular_materia1/1.0.0/angular-material.min.css”/><img src=“img/index.png”/><script type=“text/javascript” src=“https://ajax.googleapis.com/ajax/libs/angularjs/1.5.8/angular-messages.min.js”></script> These web resources may be referred to as static resources. However, web pages may have dynamic content that is obtained through AJAX requests. A simplest AJAX request structure in JavaScript code may include var xhr=new XMLHttpRequest( ); xhr.open(requestType, requestURL, isAsyncBoolean); xhr.send( );. This code may be wrapped and performed in other frameworks like jQuery, Angular, etc. that may provide helper functions, better error checking, etc., but the above AJAX request is provided as a working example for discussion. AJAX requests are web resources that may perform various function and are thus dynamic content.

Another working HTML source code example is now provided. <md-tab-item tabindex=“−1” class=“md-tab ng-scope ng-isolate-scope md-active” style=“max-width: 1589px” ng-repeat=“tab in $mdTabsCtrl.tabs” role=“tab” aria-controls=“tab-content-0” aria-selected=“true” aria-disabled=“false” ng-click=“$mdTabsCtrl.select(tab.getIndex( ))” ng-class=“{‘md-active’: tab.isActive( ), ‘md-focused’: tab.hasFocus( ), ‘md-disabled’: tab.scope.disabled}” ng-disabled=“tab.scope.disabled” md-swipe-left=“$mdTabsCtrl.nextPage( )” md-swipe-right=“$mdTabsCtrl.previousPage( )” md-tabs-template=“::tab.label” md-scope=“::tab.parent”><span class=“ng-scope”>Home</span></md-tab-item>.

In this example, “Home” is designed to be a soft page where the URL does not change in the browser display bar. The HTML element “span” is nested under the element “md-tab-item”. In some embodiments described herein, when a user selects a content item on the web page, the click to all HTML elements will be registered. Then a walk of the hierarchy in the above HTML code example will occur, looking for the elements of interest. If the user clicks and an md-tab-item is found, a new page bucket may be created. If the user clicks span element, which is not an out of box item, the walk of the hierarchy proceed to its' parents in the hierarchy. In this case, the parent of span is md-tab-item, such that the walking is exited and a new page bucket is created. This walking of the parents in the hierarchy continues to a top level element. If the two previous conditions did not result in creating a new page bucket, extension/custom code may be utilized to determine if the element should trigger a new page bucket. In additional scenario where nothing substantive on the web page was clicked by the user, no new bucket would be created. However, the clicking action may still cause a hierarchical walk of the parents.

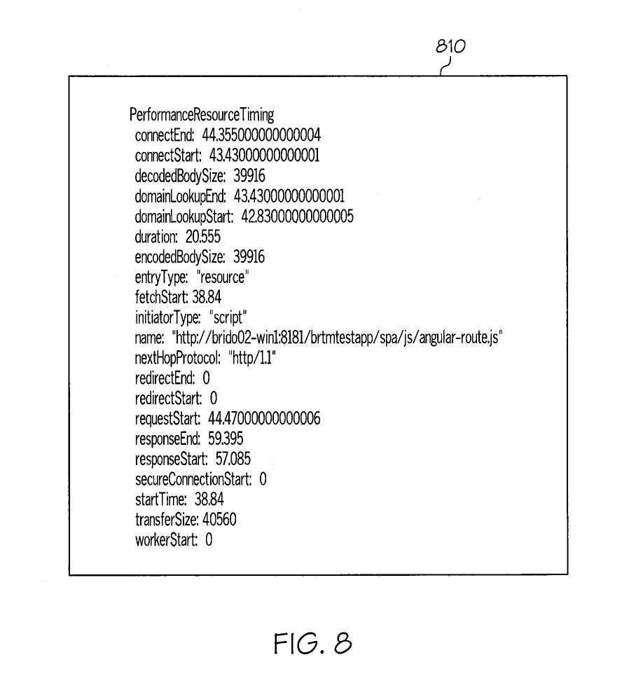

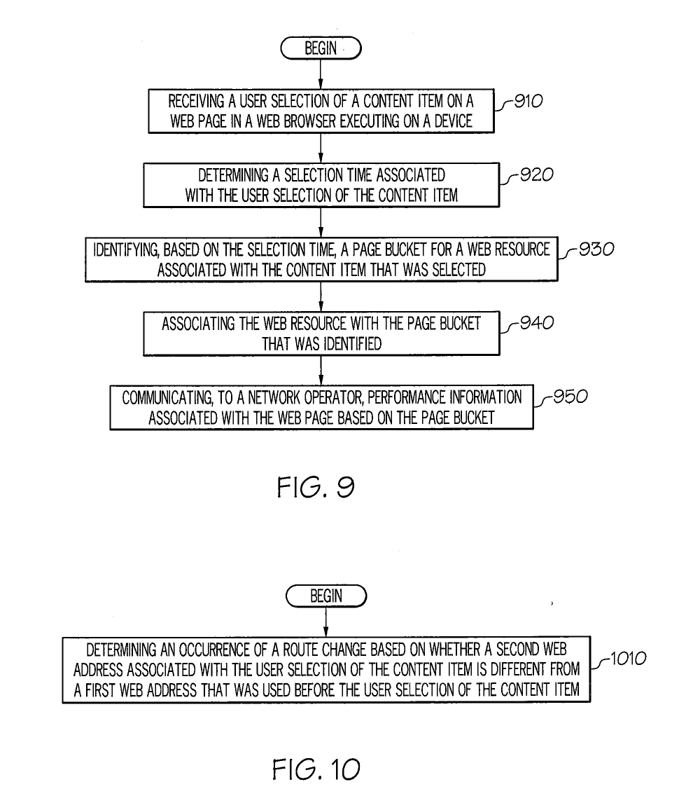

FIGS. 9 to 17 are flowcharts that illustrate operations for correlated page resources for single page applications, according to some embodiments of the inventive concept. Referring now to FIG. 9, operations may begin by receiving a user selection of a content item on a web page in a web browser executing on a device, at block 910. A selection time associated with the user selection of the content item may be determined, at block 920. Based on the selection time, a page bucket for a web resource associated with the content item that was selected may be identified, at block 930. The web resource may be associated with the page bucket that was identified, at block 940. The performance information associated with the web page based on the page bucket may be communicated to the network operator, at block 950.

The operations of FIG. 9 may be applied to either or both of the cases described earlier where the URL changes or the URL does not change. As a first example for when the URL changes, a first task may be listen for user selections such as mouse clicks. A mouse click may occur at time, t. The first task may record the time of the mouse click as lastUserClickTime=t. At some time in the future, for example 20 msec later, a second task, at t=t+20 ms may trigger an Onpopstate, which subsequently adds a new page bucket at current time=t+20 ms. A call is made to determineEventTime(lastUserClickTime) which will return time t.

As a second example for when the URL does not change, the mouse click may be recorded by a first task as occurring at time, t. A second task may receive a clicked element notification, which triggers walking of the elements and their parents. As used herein “walking” may include traversing an element and the element's immediate parent. Walking may include repetitively traversing the immediate parent's parent and may be implemented in a variety of ways such as, for example, recursively, iteratively, etc. A single page application (SPA) tag may be identified, which explicitly triggers an onpopstate function call. A call is then made to add a new page bucket with current time=t+20 ms A call is made to determineEventTime (lastUserClickTime) which will return time t.

Referring now to FIG. 10, an occurrence of a route change may be determined based on whether a second web address associated with the user selection of the content item is different from a first web address that was used before the user selection of the content item, at block 1010.

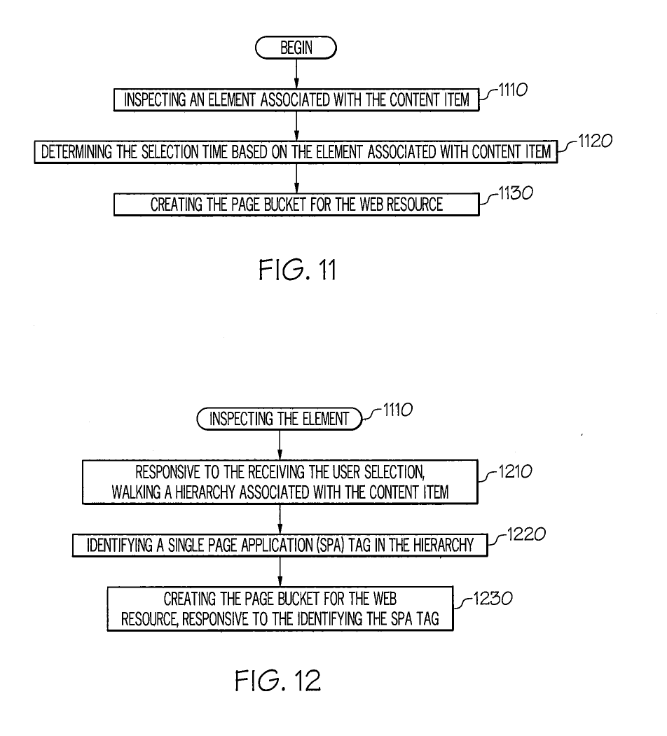

Referring now to FIG. 11, an element associated with the content item may be inspected, at block 1110. The selection time may be determined based on the element associated with the content item, at block 1120. The page bucket may be created for the web resource, at block 1130.

Referring now to FIG. 12, inspecting the element of block 1110 of FIG. 11 may include walking a hierarchy associated with the content item, responsive to receiving the user selection, at block 1210. A single page application (SPA) tag may be identified in the hierarchy that was traversed, at block 1220. The page bucket for the web resource may be created, responsive to identifying the SPA tag, at block 1230.

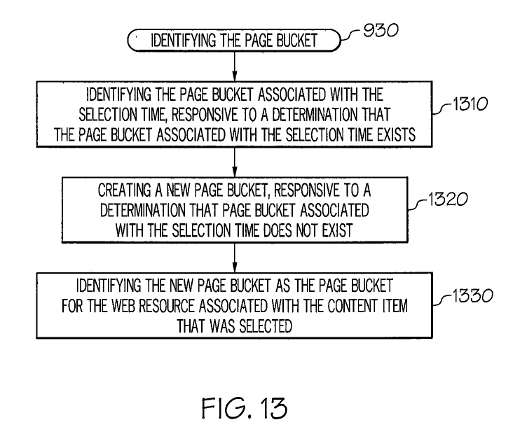

Referring now to FIG. 13, the page bucket associated with the selection time may be identified, responsive to a determination that the page bucket associated with the selection time exists, at block 1310. A new page bucket may be created based on a determination that page bucket associated with the selection time does not exist, at block 1320. The new page bucket may be identified as the page bucket for the web resource associated with the content item that was selected, at block 1330.

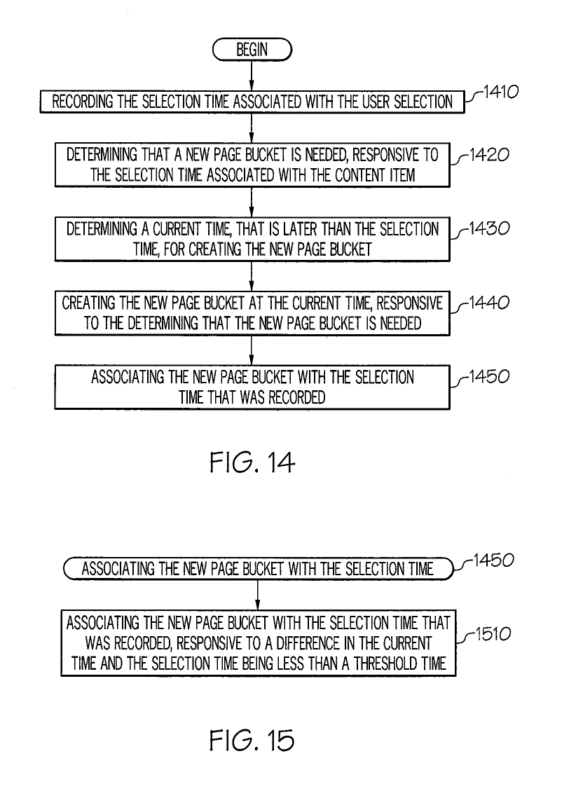

Referring now to FIG. 14, the selection time associated with the user selection may be recorded, at block 1410. It may be determined that a new page bucket is needed based the selection time associated with the content item, at block 1420. A current time that is later than the selection time may be determined for creating the new page bucket, at block 1430. The new page bucket may be created at the current time, responsive to determining that the new page bucket is needed, at block 1440. The new page bucket may be associated with the selection time that was recorded, at block 1450.

Referring now to FIG. 15, associating the new page bucket with the selection time of block 1450 of FIG. 14 may include associating the new page bucket with the selection time that was recorded, responsive to a difference in the current time and the selection time being less than a threshold time, at block 1510.

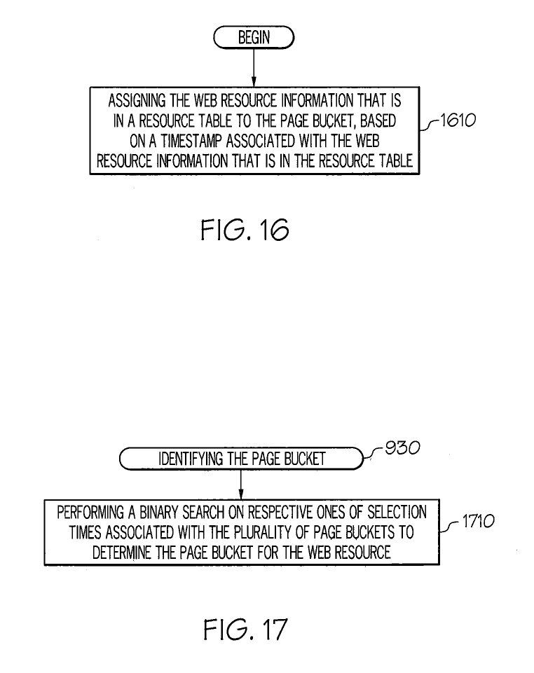

Referring now to FIG. 16, the web resource information that is in a resource table may be assigned to a page bucket, based on a timestamp associated with the web resource information that is in the resource table, at block 1610. The web resource information may be assigned to the page bucket at a harvest time at which the resource table is harvested. The harvest time may occur after the current time.

Referring now to FIG. 17, identifying the page bucket of 930 of FIG. 9 may include performing a binary search on respective ones of selection times associated with the plurality of page buckets to determine the page bucket for the web resource, at block 1710.

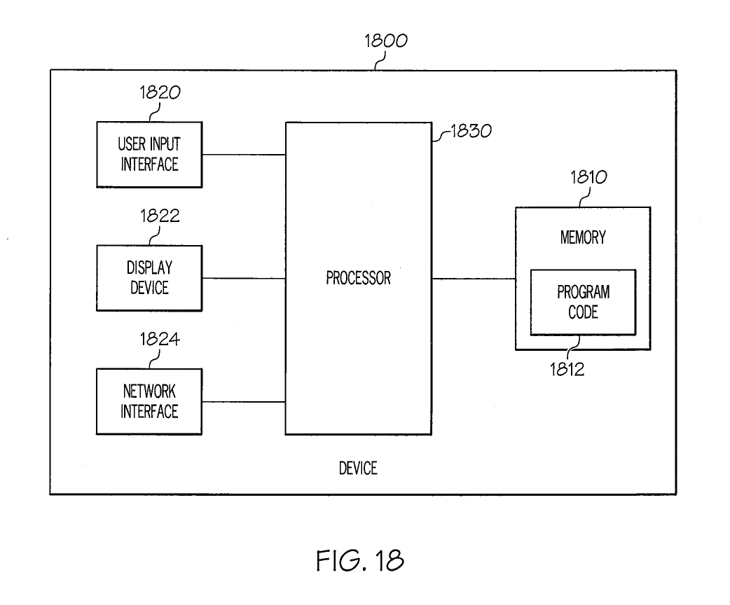

FIG. 18 is a block diagram of an electronic device 1800 configured according to some embodiments. The electronic device 1800 may include the electronic device 120 of FIG. 1. In some embodiments, electronic device 1800 may be integrated with the user device 110 or with the network operator device 130. Referring to FIG. 18, the electronic device 1800 includes a processor 183Q, a memory 1810, and a network interface 1824 which may include a radio access network transceiver and/or a wired network interface (e.g., Ethernet interface). The radio access network transceiver can include, but is not limited to, a LTE or other cellular transceiver, WLAN transceiver (IEEE 802.11), WiMax transceiver, or other radio communication transceiver configured to communicate with a service provider network or data center operator, such as network operator device 130 of FIG. 1.

The processor 1830 may include one or more data processing circuits, such as a general purpose and/or special purpose processor (e.g., microprocessor and/or digital signal processor) that may be collocated or distributed across one or more networks. The processor 1830 is configured to execute computer program code 1812 in the memory 1810, described as a non-transitory computer readable medium, to perform at least some of the operations described herein as being performed by an electronic device. The computer program code 1812 when executed by the processor 1830 causes the processor 1830 to perform operations in accordance with one or more embodiments disclosed herein for the electronic device 1800. The electronic device 1800 may further include a user input interface 1820 (e.g., touch screen, keyboard, keypad, mouse, etc.) and/or a display device 1822.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions, when stored in the computer readable medium, produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor:
receiving a user selection of a content item on a web page in a web browser executing on a device;
determining a selection time associated with the user selection of the content item;
identifying, based on the selection time, a page bucket for a web resource associated with the content item that was selected;
associating the web resource with the page bucket that was identified; and
communicating, to a network operator, performance information associated with the web page based on the page bucket.

2. The method of claim 1, further comprising:
determining an occurrence of a route change based on whether a second web address associated with the user selection of the content item is different from a first web address that was used before the user selection of the content item,
wherein the identifying the page bucket further comprises identifying the page bucket based on a route time associated with the route change.

3. The method of claim 2, responsive to a lack of the occurrence of the route change, performing operations comprising:
inspecting an element associated with the content item;
determining the selection time based on the element associated with content item; and
creating the page bucket for the web resource.

4. The method of claim 3, wherein inspecting the element comprises:
responsive to the receiving the user selection, walking a hierarchy associated with the content item;
identifying a single page application (SPA) tag in the hierarchy; and
creating the page bucket for the web resource, responsive to the identifying the SPA tag.

5. The method of claim 1, wherein the identifying the page bucket comprises:
identifying the page bucket associated with the selection time, responsive to a determination that the page bucket associated with the selection time exists;
creating a new page bucket, responsive to a determination that page bucket associated with the selection time does not exist; and
identifying the new page bucket as the page bucket for the web resource associated with the content item that was selected.

6. The method of claim 1, further comprising:
recording the selection time associated with the user selection;
determining that a new page bucket is needed, based on the selection time associated with the content item;
determining a current time, that is later than the selection time, for creating the new page bucket;
creating the new page bucket at the current time, responsive to the determining that the new page bucket is needed; and
associating the new page bucket with the selection time that was recorded.

7. The method of claim 6, wherein the associating the new page bucket with the selection time comprises:
associating the new page bucket with the selection time that was recorded, responsive to a difference in the current time and the selection time being less than a threshold time.

8. The method of claim 6,
wherein the determining that the new page bucket is needed occurs responsive to identification of a single page application (SPA) tag in a hierarchy associated with the content item.

9. The method of claim 6, wherein web resource information associated with the web resource is in a resource table, the method further comprising:
assigning the web resource information that is in a resource table to the page bucket, based on a timestamp associated with the web resource information that is in the resource table,
wherein the assigning the web resource information occurs at a harvest time that is after the current time.

10. The method of claim 9,
wherein the assigning the web resource is based on a periodic polling time interval.

11. The method of claim 1,
wherein the performance information associated with the web page comprises performance information associated with the web resource that was assigned to the page bucket.

12. The method of claim 1,
wherein the performance information associated with the web page is organized in a hierarchical structure before being communicated to the network operator.

13. The method of claim 1, wherein the page bucket is one of a plurality of page buckets, and wherein the identifying the page bucket comprises:
performing a binary search on respective ones of selection times associated with the plurality of page buckets to determine the page bucket for the web resource.

14. An electronic device, comprising:
a processor; and
a memory coupled to the processor and comprising computer readable program code embodied in the memory that when executed by the processor causes the processor to perform operations comprising:
receiving a user selection of a content item on a web page in a web browser executing on a device;
determining a selection time associated with the user selection of the content item;
identifying, based on the selection time, a page bucket for a web resource associated with the content item that was selected;
associating the web resource with the page bucket that was identified; and
communicating, to a network operator, performance information associated with the web page based on the page bucket.

15. The electronic device of claim 14, wherein the processor is further configured to perform operations comprising:
determining an occurrence of a route change based on whether a second web address associated with the user selection of the content item is different from a first web address that was used before the user selection of the content item,
wherein the identifying the page bucket further comprises identifying the page bucket based on a route time associated with the route change.

16. The electronic device of claim 15, wherein responsive to a lack of the occurrence of the route change, the processor is further configured to perform operations comprising:
inspecting an element associated with the content item;
determining the selection time based on the element associated with content item; and
creating the page bucket for the web resource.

17. The electronic device of claim 16, wherein inspecting the element comprises:
responsive to the receiving the user selection, walking a hierarchy associated with the content item;
identifying a single page application (SPA) tag in the hierarchy; and
creating the page bucket for the web resource, responsive to the identifying the SPA tag.

18. The electronic device of claim 14, wherein the processor is further configured to perform operations comprising:
recording the selection time associated with the user selection;
determining that a new page bucket is needed, responsive to the selection time associated with the content item;
determining a current time, that is later than the selection time, for creating the new page bucket;
creating the new page bucket at the current time, responsive to the determining that the new page bucket is needed; and
associating the new page bucket with the selection time that was recorded.

19. The electronic device of claim 14, wherein web resource information associated with the web resource is in a resource table, and wherein the processor is further configured to perform operations comprising:
assigning the web resource information that is in a resource table to the page bucket, based on a timestamp associated with the web resource information that is in the resource table,
wherein the assigning the web resource information occurs at a harvest time that is after the current time.

20. A computer program product, comprising:
a non-transitory computer readable storage medium storing computer readable program code which when executed by a processor of an electronic device causes the processor to perform operations comprising:
receiving a user selection of a content item on a web page in a web browser executing on a device;
determining a selection time associated with the user selection of the content item;
identifying, based on the selection time, a page bucket for a web resource associated with the content item that was selected;
associating the web resource with the page bucket that was identified; and
communicating, to a network operator, performance information associated with the web page based on the page bucket.
